(19) United States
(12) Patent Application Publication
(10) Pub. No.: US 2018/0027343 A1
(43) Pub. Date: Jan. 25, 2018

(54) HEARING AID WITH REMOTE BATTERY AND ANTENNA

(71) Applicant: Starkey Laboratories, Inc., Eden Prairie, MN (US)

(72) Inventors: Brian Dobson, Maple Grove, MN (US); Daniel A. Hanson, Maple Grove, MN (US); Gregory John Haubrich, Champlin, MN (US); Christopher Young, Shorewood, MN (US); Jeffrey Paul Solum, Greenwood, MN (US); Yoshi Kasahara, Eden Prairie, MN (US); Preetham Varghese, Eden Prairie, MN (US); Nathan Curtis Johnson, Monticello, MN (US)

(21) Appl. No.: 15/654,193

(22) Filed: Jul. 19, 2017

Related U.S. Application Data
(60) Provisional application No. 62/364,076, filed on Jul. 19, 2016.

(51) Int. Cl. H04R 25/00; H01Q 1/27; H01Q 1/22

(52) U.S. Cl. CPC H04R 25/554; H04R 25/654; H01Q 1/2208; H01Q 1/2291; H01Q 1/273

(57) ABSTRACT

A hearing aid design is described that compartmentalizes hearing aid components for easier use and better operation. In one embodiment, the processing circuitry and transducers are disposed in housing designed to placed in the ear canal so as to be isolated from antennas and sources of noise. In one embodiment, the battery is moved out of the canal in a behind-the-ear housing so that the remaining components in the ear canal are smaller so as to improve fit rate.

### PRIORITY CLAIM

This application claims priority to U.S. Provisional Patent Application Ser. No. 62/364,076, filed, Jul. 19, 2016, which is incorporated herein by reference in its entirety

### FIELD OF THE INVENTION

This invention pertains to hearing devices such as hearing aids, wireless ear-buds, head-sets, other such devices that involving hearing, and methods for their use.

### BACKGROUND

The electronic components of a hearing device may include a microphone for receiving ambient sound, processing circuitry for amplifying the microphone signal in a manner that depends upon the frequency and amplitude of the microphone signal, a speaker for converting the amplified microphone signal to sound for the wearer, and a battery for powering the components. Hearing devices may also incorporate wireless transceivers for enabling communication with an external device and/or communication between two hearing aids worn by a user.

### BRIEF DESCRIPTION OF THE DRAWINGS

FIG. 1 shows the basic electronic components of an example hearing device.

FIG. 2 illustrates an example of an on-ear module, in-ear module, and cable.

FIGS. 3A through 3E illustrate example configurations of transmission feed lines and antenna elements incorporated into the cable.

FIG. 4 illustrates an example of an on-ear module, in-ear module, and cable where a battery pack is magnetically attached to the on-ear module.

FIGS. 5 and 6 illustrate examples of a portable battery pack carrier.

### DETAILED DESCRIPTION

As the term is used herein, a hearing device or instrument may be a hearing aid, a personal sound amplification product (PSAP), a headphone set, a bearable, an earbud with senor capabilities, a wireless ear-bud, or other hearing instrument that provides sound to a user for hearing. Modern hearing devices have added wireless connectivity for purposes such as controlling and programming the devices, streaming media, and beamforming. One reason these features have been added is to improve the wearer's experience. With the advent of the new features, the power consumption of such devices has increased beyond the limit of conventional zinc-air primary cells. This has made it necessary to use rechargeable power sources such as rechargeable batteries to supply the power required for the added features. An objective of the present disclosure is to provide methods and apparatus that enable a hearing device user to replace the power source needed to run the devices in a quick and convenient manner. The features of the various embodiments described below may be used alone or in any combination considered to be advantageous.

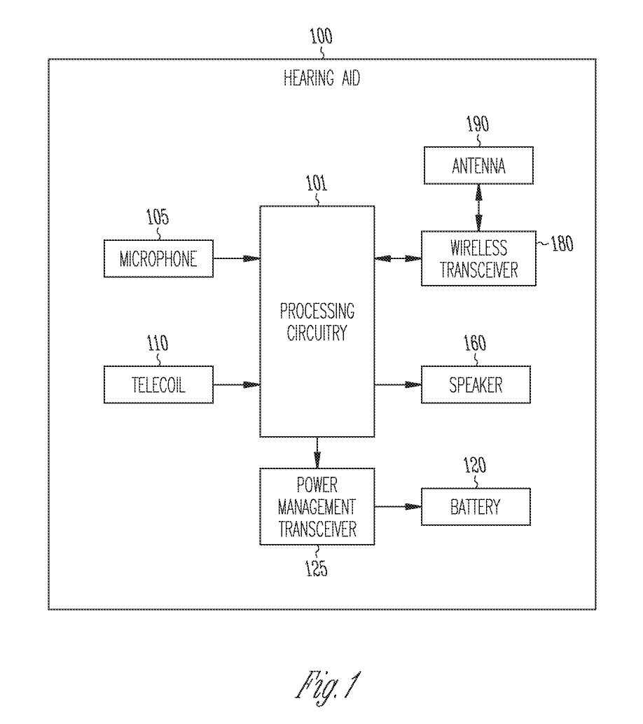

FIG. 1 illustrates the basic functional components of an example hearing device 100. In the case of bilateral hearing loss, two such hearing instruments would be worn by a user. The components of the hearing instrument may be contained within a housing or shell that may be placed, for example, in the external ear canal or behind the ear. As explained below, depending upon the type of hearing instrument, some of the components may be contained in separate housings. A microphone (or microphones) 105 receives sound waves from the environment and converts the sound into an input signal. The input signal may then be amplified by a pre-amplifier, sampled, and digitized by an A/D converter to result in a digitized input signal. The device's audio signal processing circuitry 101 processes the digitized input signal into an output signal. In a hearing aid type of hearing device, the processing circuitry 101 processes the input signal in a manner that compensates for the patient's hearing deficit. The processing circuitry 101 may be implemented in a variety of different ways, such as with an integrated digital signal processor or with a mixture of discrete analog and digital components that include a processor executing programmed instructions contained in a processor-readable storage medium. The output signal is then passed to an audio output stage that drives speaker 160 (also referred to as a receiver) to convert the output signal into an audio output. A battery 120 operated by power management circuitry 125 supplies power for the hearing instrument components.

Hearing instruments may incorporate wireless transceivers that enable communication between the two hearing instruments typically worn by a user as well as communication between a hearing instrument and an external device such as an external programmer or an audio streaming source such as a smartphone. In the case of ear-to-ear communication, the link between the hearing instruments may be implemented as a near-field magnetic induction (NFMI) link operated in a frequency band between 3 and 15 MHz which easily propagates through and around the human head. The frequency band used for NFMI links, however, has a very limited propagation range. Therefore, in the case of communications between a hearing instrument and an external device, far-field RF (radio-frequency) links using higher frequency bands such as the 900 MHz or 2.4 GHz ISM (Industrial Scientific Medical) bands are preferred. Wireless transceivers also need an antenna for radio transmission and reception that requires the hearing instrument to incorporate one or more antennas. The example device illustrated by FIG. 1 includes a wireless transceiver 180 is interfaced to the hearing instrument's processing circuitry and connected to the feedpoint of an antenna (or antennas) 190 for transmitting and/or receiving radio signals. The wireless transceiver 180 may enable ear-to-ear communications between the two hearing instruments as well as communications with an external device. Such long range communication may be possible using Bluetooth, WiFi (802.x), or other standards such as 802.15.x. Wireless communication may include direct connection to a cellular network using GSM, CDMA, TDMA, 4G, LTE and the like. The later not being possible using a typical Zinc-Air battery but would be possible with a rechargeable battery capable of high peak power supply. When receiving an audio signal from an external source, the wireless receiver 180 may produce a second input signal for the processing circuitry that may be combined with the input signal produced by the microphone 105 or used in place thereof.

The example device illustrated by FIG. 1 also includes telecoil 110 (also referred to as a T-coil for “telephone coil”) which is a small device that detects the electromagnetic field generated by audio induction loops such as the speaker of a telephone handset. The signal from the telecoil is digitized and fed to the processing circuitry 101 where it is mixed with the microphone signal to generate the audio output for the hearing instrument wearer when the hearing instrument is operating in a telecoil mode. The telecoil mode may be activated manually via a user input or may be activated automatically when the presence of a magnetic field produced by the magnet of a telephone speaker is sensed by, for example, a magnetometer.

In certain types of hearing instruments, the electronic components are enclosed by a housing or shell that is designed to be worn in the ear for both aesthetic and functional reasons. Such devices may be referred to as in-the-ear (ITE), in-the-canal (ITC), completely-in-the-canal (CIC), or invisible-in-the-canal (IIC) hearing instruments. Another type of hearing instrument, referred to as a behind-the-ear (BTE) hearing instrument, utilizes a housing that is worn behind the ear that contains all of the components shown in FIG. 1 including the receiver (i.e., the speaker) that conducts sound to an earbud inside the ear via an audio tube. Another type, referred to as a receiver-in-canal (RIC) hearing instrument, also has a housing worn behind the ear that contains all of the components shown in FIG. 1 except for the receiver, with the output state then being electrically connected to the receiver worn in the ear canal.

Current in-the-ear hearing instruments such as IIC devices have limited capabilities. These include short battery life, lower fit rates due to the volume of components to be placed in the canal, lack of wireless features like programming and streaming, no telecoil, and patient frustration with changing batteries. Current BTE and RIC devices also have limitations such as antenna and telecoil interference with radio circuitry, fixed battery life, fixed size and color, more limited microphone directionality than ITE devices, patient frustration with changing batteries, and inability to change-out rechargeable batteries if depleted during a day of usage. These devices may also suffer from mechanical failures of battery doors, including: case gaps/ingress points, mechanical failure of the battery door part, poor detents making the off position hard to recognize, an open battery door causing the microphone cover to fall off, battery contact intermittency, and battery contact bending or breakage.

Described herein is a modular design for hearing devices that compartmentalizes the components such as illustrated in FIG. 1 in a manner that addresses the problems discussed above. In one embodiment, the processing circuitry 101 and transducers (e.g., microphone 105 and receiver 160) are disposed in a housing designed to be placed in the ear canal so as to be isolated from antennas and sources of noise. In one embodiment, the battery is moved out of the canal in a behind-the-ear housing so that the remaining components in the ear canal are smaller so as to improve fit rate. Having a smaller in-canal module also enables the creation of a small standard, open fit device. Moving the battery behind the ear with an electrical connector to the rest of the device enables: 1) patient-changeable case size, style and color, 2) patient selectable battery life, 3) the ability to change battery chemistries as technology develops, 4) wired charging through the connector, and 5) placement of antennas and circuitry behind the ear. Using a rechargeable battery with wireless or wired charging eliminates the battery door and battery contacts, reduces part count (cost), spares patients the frustration of dealing with small batteries, and allows replacement of rechargeable batteries if depleted mid-day (e.g. if recharging were to be skipped or forgotten).

In some embodiments, a hearing device includes an in-ear module and an on-ear module, where each such module comprises a housing containing components for giving the device functionality. The on-ear module is adapted to be worn outside of the ear or on the ear, while the in-ear module is adapted to be worn in the ear canal. The on-ear module may include a battery (either rechargeable or replaceable) and power management circuitry for conditioning power transfer between the battery and electronic components of the on-ear module and the in-ear module. In some embodiments, the battery is an external rechargeable battery pack that connects to the on-ear module via a magnetic or mechanical connection. A cable connecting the on-ear module to the in-ear module may comprise a conductor for transferring power from the battery to the in-ear module. The on-ear module may include a wireless transceiver and associated circuitry for wireless communication (e.g., Bluetooth). In some embodiments, a portion of the cable connecting the on-ear module to the in-ear module may be used as an antenna. The in-ear module may contain transducers and audio signal processing circuitry. In one embodiment, the in-ear module contains a receiver, while the on-ear module contains a microphone and audio signal processing circuitry as in a traditional RIC hearing instrument. In another embodiment, the in-ear module contains a receiver, a microphone, and audio signal processing circuitry as in a traditional CIC hearing instrument.

The cable connecting the on-ear module and the in-ear module may comprise conductors for power transfer, ground, data transfer, and wireless antenna functions. These types of electrical signals may also be multiplexed over one or more conductors since the signals have different frequency content and can be easily separated by filtering. For example, wireless communications signals radiated and received by the antenna such as for Bluetooth communication may be at 2.4 GHz, the power signal may be at DC, and the data signal may be at baseband frequencies that are less than 100 MHz.

In some embodiments, a hearing device comprising an in-ear module and an on-ear module as described above may also include a separate in-ear battery pack that can be connected to the in-ear module. The in-ear battery pack may be smaller than the battery pack used for the on-ear module (e.g., a 10 A battery) and be connected to the in-ear module via a mechanical connector such as a bayonet or screw-on type connector or by a magnetic connector. In these embodiments, the device may then be operated in an untethered mode where the on-ear module and cable are detached from the in-ear module so that the in-ear module is worn alone. In this way the user may choose to conceal his or her hearing impairment by using only the in-ear module with its separate battery pack in the untethered mode or may choose to have full wireless connectivity and convenience of an on ear rechargeable battery pack in the tethered mode.

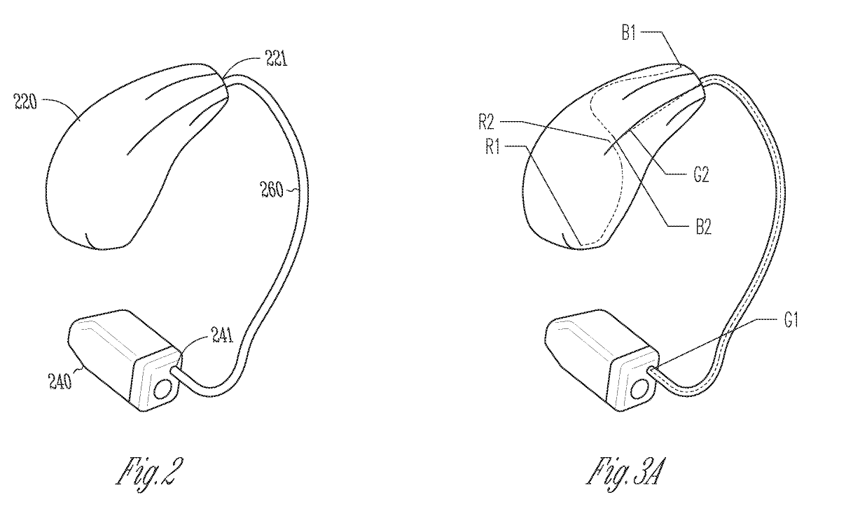

In an example embodiment, a hearing device includes three main components as illustrated in FIG. 2: an on-ear module 220 incorporating a battery pack designed to be worn on or behind the ear, an in-ear module 240 designed to be worn in the ear canal, and a cable 260 with connectors for connecting the in-ear module to the on-ear module. Various embodiments for these components are described below.

The battery pack of the on-ear module 220 may be patient-changeable and may contain batteries of any chemistry (e.g., rechargeable). In one embodiment, a combination of rechargeable batteries and a primary/replaceable battery are used. For example, if a user forgets to recharge the rechargeable battery, a 10 A Zn-Air battery could be inserted to allow continued operation until a time when recharging is possible. In another embodiment, the rechargeable batteries may be partitioned into two portions: 1) a main rechargeable, higher-capacity battery, and 2) a “reserve” rechargeable, lower-capacity battery. Once the main rechargeable battery is depleted, the reserve capacity battery could be switched in for use. This avoids disconnecting/connecting a fresh behind-the-ear battery (which can be difficult for some elderly patients) but allows extended use if a patient forgets to recharge the battery or if a spare battery is not immediately available (or it is not a convenient time to change the battery).

The on-ear module 220 may also contain the power management circuitry 125, telecoil 110, wireless transceiver 180, and an antenna 190 (or a portion thereof). In one embodiment, the on-ear module 220 also includes a charging antenna (inductive or RF) for wirelessly recharging the battery or batteries 120 and/or includes photo-voltaic cells on its surface for battery recharging. The cable connector of the on-ear module may be a self-aligning magnetic design. The wireless transceiver 180 may be capable of operating in different frequency bands so that different battery packs operate in a frequency band that has radio regulatory compliance with the country intended for sale. For example, the wireless transceiver may operate in the 900 MHz or 2.4 GHz RF bands or may be an NFMI transceiver with NFMI coil. In one embodiment, the wireless transceiver and antennas may be designed for both NFMI and RF operation. In still another embodiment, two antennas may be incorporated and or two receivers for both NFMI and long-range RF communication.

The in-ear module 240 may contain any or all of the following components: processing circuitry 101, one or more microphones 105, receiver 160, and wireless transceiver 180. The canal module 240 may also incorporate features for venting and/or wax protection. In some embodiments, the in-ear module 240 may also incorporate a telecoil, an RF Antenna (or a portion thereof) and or an NFMI coil (e.g., for audio streaming).

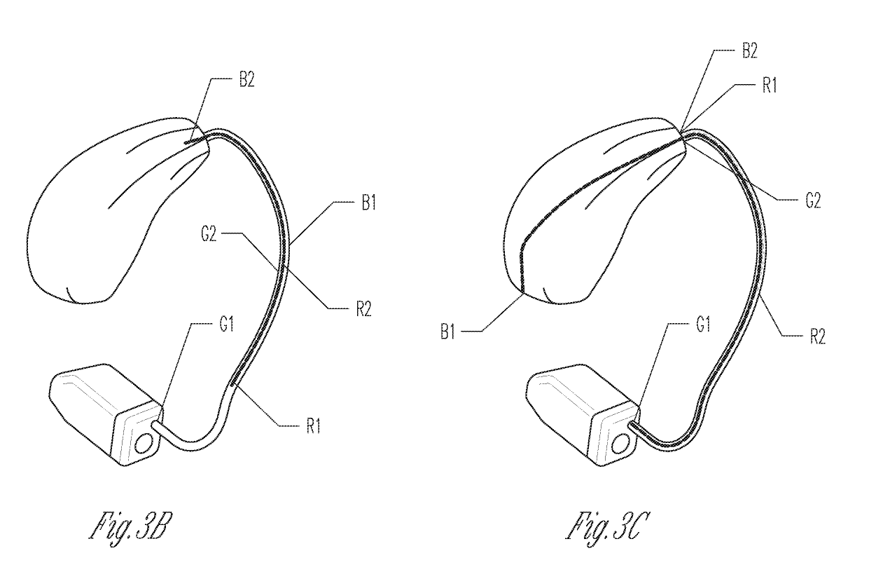

The cable 260 connects to the on-ear module 220 via cable connector 221 and connects to the in-ear module 240 via cable connector 241. The cable 260 could also be molded into the housing of the on-ear module or fixed to the housing as without a separate connector 241. The cable 260 may also contain elements of the antenna 190 and/or contain a transmission feed line for transporting RF energy between the wireless transceiver 180 and antenna 190. FIGS. 3A through 3E illustrate different embodiments of the cable 260 in which segments of cable between points B1 and B2 (B1-B2 segment), between points G1 and G2 (G1-G2 segment), between points R1 and R2 (R1-R2 segment), and between points Y1 and Y2 (Y1-Y2 segment) represent different functions. Each of the figures represents a different embodiment/topology for the transmission feed-line and antenna elements.

The G1-G2 portion represents the RF transmission-line which is mostly non-radiating and serves to transfer RF energy between the transceiver and the antenna feed-point. The transmission-line serves to allow flexible placement of the antenna's feed-point to be either: within the canal module, at the canal module/cable boundary, within the length of the cable, at the cable/battery-case boundary, or within the battery case boundary. The transmission-line also serves to allow the active portions of the antenna (B1-B2/R1-R2 or B1-B2/Y1-Y2) to remain relatively constant in dimensions even as the overall length of the cable 260 is varied to fit individual hearing instrument users. The transmission-line portion of the cable may also be of one of several options: 1) coaxial, 2) two or more-conductors balanced (e.g. two on one side, and two on the other side, roughly symmetrical), either twisted or non-twisted, or 3) three or more conductors unbalanced (e.g. one or more conductors, being partially shielded by one or more conductors).

The B1-B2 portion of the cable 260 represents one element of the two primary radiating elements of the antenna. In the case of FIGS. 3A, 3B, and 3C, the B1-B2 segment is one element of a two-element dipole-like antenna. In FIGS. 3D and 3E, the B1-B2 segment is the monopole element in a monopole with counterpoise or monopole with ground-plane configuration. The length of the B1-B2 antenna element may be shorter or longer than what is depicted in the figures. The B1-B2 antenna element may include a battery (or batteries) or battery contact metal traces or wires. In some embodiments, the B1-B2 segment may not be a separate wire from the power wires partially contained in the cable 260. Alternatively, the B1-B2 segment may be a conformal conductive surface or embedded conductor on or within the on-ear or in-ear module.

The R1-R2 portion represents one element of two primary radiating elements of the antenna. In the case of FIGS. 3A, 313, and 3C, the R1-R2 segment is one element of a two-element dipole-like antenna. The length of the R1-R2 antenna element may be shorter, or longer than depicted in the figures. The R1-R2 antenna element may include a battery (or batteries) or battery contact metal traces or wires. In some embodiments, the R1-R2 segment may not be a separate wire from the power wires partially contained in the cable 260. In FIG. 3D, the R1-R2 segment represents a counterpoise or ground-plane configuration. Note that R1-R2 and/or B1-B2 may alternately consist of thin conductive surfaces conformal to the hearing instrument shell (internally, externally, attached to the shell/case, or a separate structure such as a flex circuit).

The Y1-Y2 segment represents a ground plane. The ground plane may be any combination, or all, of the following: 1) circuit-substrate ground plane, 2) circuit-substrate power-plane, 3) traces on a circuit substrate (either tuned counterpoise, or non-tuned trace or traces), and 4) any conductive element within, or on, or connected to, the hearing instrument. Inductors, capacitors, high-pass filters, low-pass filters, and/or ferrite beads may be used to multiplex (or diplex) conductors to allow the conductors to be used for low-frequency, DC, and/or RF signals associated with the wireless transceiver 180 as either a transmission feed line, antenna element, or both. A radiating antenna (other than a loop) contains at least two radiating portions (either in dipole-like configuration or in a monopole configuration with ground-plane/counterpoise).

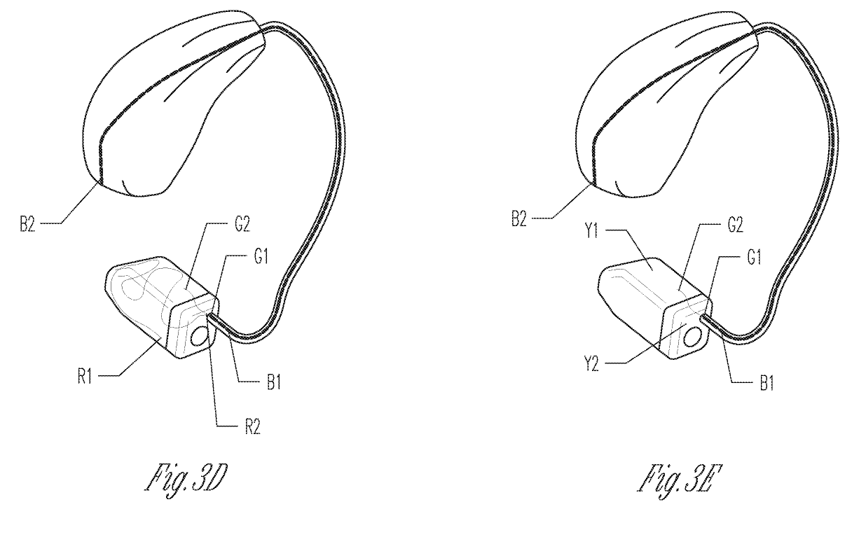

FIG. 4 illustrates an example embodiment showing an on-ear module 220 with a magnetic connector 225 for attaching a battery pack 230. The cable 260 connects to the on-ear module 220 via cable connector 221 and connects to the in-ear module 240 via cable connector 241. The cable 260 may carry power and data and may also function as a wireless antenna or portion of a wireless antenna. In some embodiments, the in-ear module 240 is an RIC-type device and cannot be operated without being connected to the on-ear module 220. In other embodiments, the in-ear module includes a microphone, receiver, and processing circuitry so as to be able to operate in an untethered mode without the on-ear module 220. In that case, the cable connector 241 may be replaced with a smaller in-ear battery pack, or the in-ear module 240 may contain a place for a small (rechargeable) battery within the housing of the in-ear module 240.

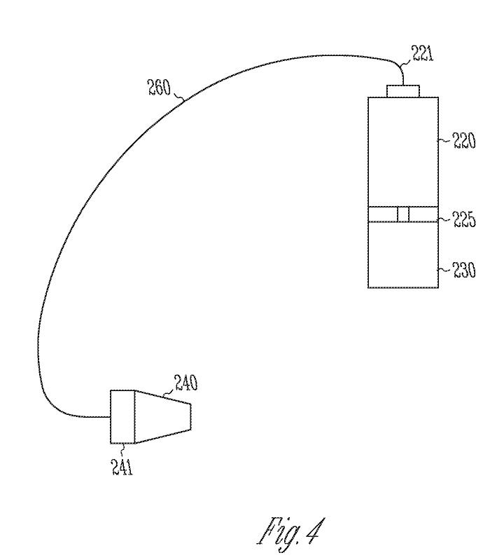

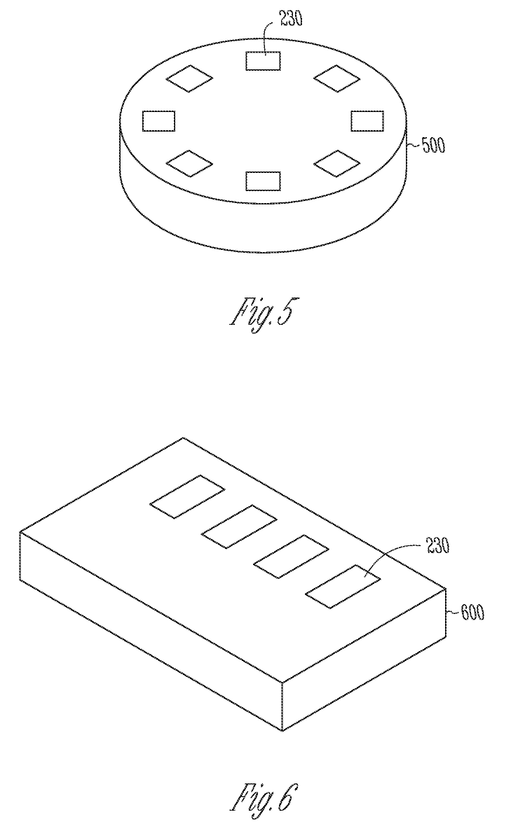

In another embodiment, a portable carrier is provided for containing a number of rechargeable battery packs that may be magnetically attached to the on-ear module as described above and for recharging the battery packs. A user is then able to recharge a set of battery packs contained in the portable carrier. In some embodiments, the portable carrier may contain a larger battery capable of charging one or more small rechargeable battery packs that can be used to power the hearing device. In some embodiments, the battery packs contained in the portable battery carrier may be recharged using a USB cable supplied from a DC power source plugged into an AC/DC converter or from any USB device capable of supplying power for recharge. In one embodiment, the portable battery carrier contains a larger rechargeable or one time use battery capable of recharging the depleted hearing instrument battery packs. The portable carrier thus allows the user to replace the hearing devices' depleted power source with a fully charged power source in a quick and easy manner. In one embodiment, once the user depletes a battery pack, the processing circuitry of the hearing device is configured to send an audible warning to the user that prompts the user to remove the hearing device and place it into the portable carrier equipped with an already recharged battery pack. The portable carrier may be designed so that the user turns or slides the hearing device mounted in the portable case to a position that will remove and replace the worn out battery pack for a new fully charged battery pack. The portable carrier may incorporate a sliding mechanism or a rotating carousel mechanism to perform the transfer from a depleted battery to a freshly recharged battery pack. FIG. 5 illustrates an example of a portable carrier 500 that incorporates a rotating carousel mechanism and contains multiple battery packs 230. FIG. 6 illustrates an example of a portable carrier 600 that incorporates a sliding mechanism and contains multiple battery packs 230. Once attached to the portable carrier, the depleted batteries may then be recharged and made ready for the user the next time he or she needs a new set. The hearing device may be mounted or attached to the portable carrier via a magnetic connector similar to the magnetic connector that attaches the battery pack to the on-ear module.

### Example Embodiments

In Example 1, a hearing device comprises: an in-ear module adapted for insertion into a user's outer ear canal; a microphone, receiver, and processing circuitry incorporated into the in-ear module; an on-ear module adapted for wearing on or behind a user's ear; a battery pack incorporated into the on-ear module; and, a cable for electrically connecting components of the on-ear and in-ear modules.

In Example 2, the subject matter of any of the Examples herein may optionally include a wireless transceiver incorporated into the on-ear module.

In Example 3, the subject matter of any of the Examples herein may optionally include wherein different segments of the cable serve as a transmission feed line or as radiating antenna elements for the wireless transceiver.

In Example 4, the subject matter of any of the Examples herein may optionally include wherein the battery pack is housed within a housing of the on-ear module.

In Example 5, the subject matter of any of the Examples herein may optionally include wherein the battery pack is external to a housing of the on-ear module and magnetically attachable thereto.

In Example 6, the subject matter of any of the Examples herein may optionally include the on-ear module incorporates power management circuitry for supplying power from the battery pack to the in-ear module.

In Example 7, the subject matter of any of the Examples herein may optionally include an in-ear battery pack for attaching to the in-ear module to enable the in-ear module to operate in an untethered mode without being connected to the on-ear module.

In Example 8, the subject matter of any of the Examples herein may optionally include wherein the on-ear module is adapted to be placed in a portable battery pack carrier that utilizes a mechanism for removing and replacing the battery pack.

In Example 9, the subject matter of any of the Examples herein may optionally include wherein the cable incorporates multiple conductors for functioning as a wireless communications antenna, for transferring data between the on-ear and in-ear modules, and for transferring power from the battery pack to the in-ear module.

In Example 10, the subject matter of any of the Examples herein may optionally include wherein the battery pack is rechargeable.

In Example 11, the subject matter of any of the Examples herein may optionally include wherein the on-ear module incorporates circuitry configured to provide an audible alarm to a user when the battery pack needs to be recharged or replaced.

In Example 12, a hearing device comprises: an in-ear module adapted for insertion into a user's outer ear canal; a receiver incorporated into the in-ear module; an on-ear module adapted for wearing on or behind a user's ear; a microphone, processing circuitry, and battery pack incorporated into the on-ear module; a cable for electrically connecting components of the on-ear and in-ear modules; and, wherein the battery pack is external to a housing of the on-ear module and magnetically attachable thereto.

In Example 13, the subject matter of any of the Examples herein may optionally include a wireless transceiver incorporated into the on-ear module.

In Example 14, the subject matter of any of the Examples herein may optionally include wherein different segments of the cable serve as a transmission feed line or as radiating antenna elements for the wireless transceiver.

In Example 15, the subject matter of any of the Examples herein may optionally include wherein the cable incorporates multiple conductors for functioning as a wireless communications antenna, for transferring data between the on-ear and in-ear modules, and for transferring power from the battery pack to the in-ear module.

In Example 16, a hearing device, comprises: an in-ear module adapted for insertion into a user's outer ear canal; an on-ear module adapted for wearing on or behind a user's ear; a battery pack incorporated into the on-ear module; a wireless transceiver incorporated in to the on-ear module; and, a cable for electrically connecting components of the on-ear and in-ear modules, wherein the cable is able to transfer power from the battery pack to the in-ear module and act as an antenna for the wireless transceiver.

In Example 17, the subject matter of any of the Examples herein may optionally include a microphone, receiver, and processing circuitry incorporated into the in-ear module.

In Example 18, the subject matter of any of the Examples herein may optionally include a receiver and processing circuitry incorporated into the in-ear module and a microphone incorporated into the on-ear module.

In Example 19, the subject matter of any of the Examples herein may optionally include wherein the battery pack is external to a housing of the on-ear module and magnetically attachable thereto.

In Example 20, the subject matter of any of the Examples herein may optionally include wherein the cable incorporates multiple conductors for functioning as a wireless communications antenna, for transferring data between the on-ear and in-ear modules, and for transferring power from the battery pack to the in-ear module.

In Example 21, a method may comprise performing any of the functions recited in the Examples herein.

In Example 22, a device may comprise means for performing any of the functions recited in the Examples herein.

It is understood that digital hearing instruments may include a processor or processing circuitry. In digital hearing instruments with a processor, programmable gains may be employed to adjust the hearing instrument output to a wearer's particular hearing impairment. The processor may be a digital signal processor (DSP), microprocessor, microcontroller, other digital logic, or combinations thereof. The processing may be done by a single processor, or may be distributed over different devices. The processing of signals referenced in this application can be performed using the processor or over different devices. Processing may be done in the digital domain, the analog domain, or combinations thereof. Processing may be done using subband processing techniques. Processing may be done using frequency domain or time domain approaches. Some processing may involve both frequency and time domain aspects. For brevity, in some examples drawings may omit certain blocks that perform frequency synthesis, frequency analysis, analog-to-digital conversion, digital-to-analog conversion, amplification, buffering, and certain types of filtering and processing. In various embodiments the processor is adapted to perform instructions stored in one or more memories, which may or may not be explicitly shown. Various types of memory may be used, including volatile and nonvolatile forms of memory. In various embodiments, the processor or other processing devices execute instructions to perform a number of signal processing tasks. Such embodiments may include analog components in communication with the processor to perform signal processing tasks, such as sound reception by a microphone, or playing of sound using a receiver (i.e., in applications where such transducers are used). In various embodiments, different realizations of the block diagrams, circuits, and processes set forth herein can be created by one of skill in the art without departing from the scope of the present subject matter.

It is further understood that different hearing devices may embody the present subject matter without departing from the scope of the present disclosure. The devices depicted in the figures are intended to demonstrate the subject matter, but not necessarily in a limited, exhaustive, or exclusive sense. It is also understood that the present subject matter can be used with a device designed for use in the right ear or the left ear or both ears of the wearer.

The present subject matter is demonstrated for hearing devices, including hearing instruments, including but not limited to, behind-the-ear (BTE), in-the-ear (ITE), in-the-canal (ITC), invisible-in-the-canal (IIC), receiver-in-canal (RIC), or completely-in-the-canal (CIC) type hearing aids. It is understood that behind-the-ear type hearing aids may include devices that reside substantially behind the ear or over the ear. Such devices may include hearing aids with receivers associated with the electronics portion of the behind-the-ear device, or hearing aids of the type having receivers in the ear canal of the user, including but not limited to receiver-in-canal (RIC) or receiver-in-the-ear (RITE) designs.

This application is intended to cover adaptations or variations of the present subject matter. It is to be understood that the above description is intended to be illustrative, and not restrictive. The scope of the present subject matter should be determined with reference to the appended claims, along with the full scope of legal equivalents to which such claims are entitled.

What is claimed is:

1. A hearing device, comprising:
an in-ear module adapted for insertion into a user's outer ear canal;
a microphone, receiver, and processing circuitry incorporated into the in-ear module;
an on-ear module adapted for wearing on or behind a user's ear;
a battery pack incorporated into the on-ear module; and,
a cable for electrically connecting components of the on-ear and in-ear modules.

2. The device of claim 1 further comprising a wireless transceiver incorporated into the on-ear module.

3. The device of claim 2 wherein different segments of the cable serve as a transmission feed line or as radiating antenna elements for the wireless transceiver.

4. The device of claim 1 wherein the battery pack is housed within a housing of the on-ear module.

5. The device of claim 1 wherein the battery pack is external to a housing of the on-ear module and magnetically attachable thereto.

6. The device of claim 1 wherein the on-ear module incorporates power management circuitry for supplying power from the battery pack to the in-ear module.

7. The device of claim 1 further comprising an in-ear battery pack for attaching to the in-ear module to enable the in-ear module to operate in an untethered mode without being connected to the on-ear module.

8. The device of claim 1 wherein the on-ear module is adapted to be placed in a portable battery pack carrier that utilizes a mechanism for removing and replacing the battery pack.

9. The device of claim 1 wherein the cable incorporates multiple conductors for functioning as a wireless communications antenna, for transferring data between the on-ear and in-ear modules, and for transferring power from the battery pack to the in-ear module.

10. The device of claim 1 wherein the battery pack is rechargeable.

11. The device of claim 1 wherein the on-ear module incorporates circuitry configured to provide an audible alarm to a user when the battery pack needs to be recharged or replaced.

12. A hearing device, comprising:
an in-ear module adapted for insertion into a user's outer ear canal;
a receiver incorporated into the in-ear module;
an on-ear module adapted for wearing on or behind a user's ear;
a microphone, processing circuitry, and battery pack incorporated into the on-ear module;
a cable for electrically connecting components of the on-ear and in-ear modules; and,
wherein the battery pack is external to a housing of the on-ear module and magnetically attachable thereto.

13. The device of claim 12 further comprising a wireless transceiver incorporated into the on-ear module.

14. The device of claim 13 wherein different segments of the cable serve as a transmission feed line or as radiating antenna elements for the wireless transceiver.

15. The device of claim 13 wherein the cable incorporates multiple conductors for functioning as a wireless communications antenna, for transferring data between the on-ear and in-ear modules, and for transferring power from the battery pack to the in-ear module.

16. A hearing device, comprising:
an in-ear module adapted for insertion into a user's outer ear canal;
an on-ear module adapted for wearing on or behind a user's ear;
a battery pack incorporated into the on-ear module;
a wireless transceiver incorporated in to the on-ear module; and,
a cable for electrically connecting components of the on-ear and in-ear modules, wherein the cable is able to transfer power from the battery pack to the in-ear module and act as an antenna for the wireless transceiver.

17. The device of claim 16 further comprising a microphone, receiver, and processing circuitry incorporated into the in-ear module.

18. The device of claim 16 further comprising a receiver and processing circuitry incorporated into the in-ear module and a microphone incorporated into the on-ear module.

19. The device of claim 16 wherein the battery pack is external to a housing of the on-ear module and magnetically attachable thereto.

20. The device of claim 16 wherein the cable incorporates multiple conductors for functioning as a wireless communications antenna, for transferring data between the on-ear and in-ear modules, and for transferring power from the battery pack to the in-ear module.
